(19) United States
(12) Patent Application Publication
(10) Pub. No.: US 2020/0242643 A1
(43) Pub. Date: Jul. 30, 2020

(54) MARKETING SUPPORT SYSTEM, MARKETING SUPPORT METHOD AND PROGRAM

(71) Applicant: Strategy Partners Co., Ltd., Minato-ku (JP)

(72) Inventor: Kazuki Nishiguchi, Minato-ku (JP)

(21) Appl. No.: 16/593,787

(22) Filed: Oct. 4, 2019

(30) Foreign Application Priority Data
Jan. 24, 2019 (JP) 2019-010157

(51) Int. Cl. G06Q 30/02

(52) U.S. Cl. CPC G06Q 30/0204; G06Q 30/0245

(57) ABSTRACT

A marketing support system to provide the tool includes an acquisition unit acquiring questionnaire information including a response result of a questionnaire and an attribute of a respondent of the questionnaire, the questionnaire conducted to consumers in a product and service field to which a marketing target belongs, regarding recognition, usage experience and frequency of use of a brand belonging to the field, an assignment unit for assigning the respondent to any one of a plurality of segments set in advance based on the response result, a an aggregation unit configured to aggregate the respondent assigned to a corresponding segment by attribute with respect to each of the plurality of segments, and an output unit for displaying an aggregation result of the aggregation unit between different segments for comparison.

### CROSS REFERENCE TO RELATED APPLICATION

The present application claims priority under 35 U.S.C § 119(a) to Japanese application number, 2019-010157, filed on Jan. 24, 2019 in the Japanese Intellectual Property Office, which is incorporated herein by reference in its entirety.

### TECHNICAL FIELD

The present invention relates to a marketing support system, a marketing support method and program.

### BACKGROUND ART

For example, the following Patent Document 1 discloses a method for creating a product offer of a retailer and notifying it to a consumer. This method is a method of combining a loyalty of a store or retailer and a loyalty of a product to identify specific consumers and consumer groups to sell.

### PRIOR ART LITERATURE

### Patent Document

[Patent Document 1] Japanese Patent Publication No. 2008-521143

### DESCRIPTION OF THE INVENTION

### Technical Problem

Now, for an effective marketing activity, it is important to have an appropriate approach according to a customer segment. For example, expanding an approach for a specific segment to other segments is not appropriate as a marketing strategy.

However, the development of an approach according to a customer segment and segment analysis as its premise is not easy and takes time.

The present invention has been made in view of such background, and is directed to provide a tool that can easily carry out segment analysis for appropriate marketing activities.

### Technical Solution

The main invention of the present invention for solving the above problems is provided with, a marketing support system including, an acquisition unit acquiring questionnaire information including a response result of a questionnaire and an attribute of a respondent of the questionnaire, the questionnaire conducted to consumers in a product and service field to which a marketing target belongs, regarding recognition, usage experience and frequency of use of a brand belonging to the field, an assignment unit for assigning the respondent to any one of a plurality of segments set in advance based on the response result, an aggregation unit configured to aggregate the respondent assigned to a corresponding segment by attribute with respect to each of the plurality of segments, and an output unit for displaying an aggregation result of the aggregation unit between different segments for comparison.

Other problems and solutions disclosed in the present application will be made clear by the section of the embodiments of the present invention and the accompanying drawings.

### Advantageous Effects

According to the present invention, segment analysis can be easily performed. Therefore, it is possible to facilitate creating a hypothesis and support effective marketing activities.

### DESCRIPTION OF THE DRAWINGS

FIG. 1 is a diagram illustrating an example of an overall configuration of a system including an operator terminal 10, a marketing support system 20, and a questionnaire system 30 in the present embodiment.

FIG. 2 is a diagram illustrating an example of a hardware configuration of a computer used as a marketing support system 20.

FIG. 3 is a diagram illustrating an example of a software configuration of a marketing support system 20.

FIG. 4 is a diagram illustrating an example of a customer segment.

FIG. 5 is a diagram illustrating another example of a customer segment.

FIG. 6 is a diagram illustrating an example of a questionnaire.

FIG. 7 is a flow diagram illustrating an example of a method for assigning a customer to a segment from a questionnaire response.

FIG. 8 is a diagram illustrating an example of a calculation method of the number of users of each segment.

FIG. 9 is a diagram illustrating an example of a display to be output.

FIG. 10 is a diagram illustrating another example of a display to be output.

FIG. 11 is a diagram illustrating yet another example of a display to be output.

FIG. 12 is a diagram illustrating yet another example of a display to be output.

FIG. 13 is a diagram illustrating yet another example of a display to be output.

FIG. 14 is a diagram illustrating another example of a display to be output.

FIG. 15 is a diagram illustrating another example of a display to be output.

FIG. 16 is a diagram illustrating an example of an operation of the marketing support system 20.

### MODE FOR CARRYING OUT THE INVENTION

Hereinafter, a marketing support system according to an embodiment of the present invention will be described with reference to the accompanying drawings. However, the present invention is not limited thereto.

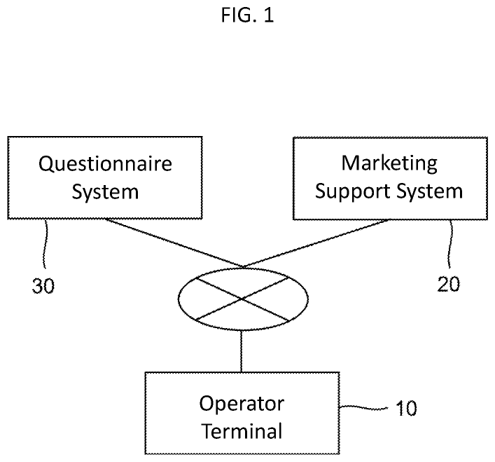

An example of an overall configuration of a system in the present embodiment will be described. FIG. 1 is a diagram illustrating an example of an overall configuration of a system including an operator terminal 10, a marketing support system 20, and a questionnaire system 30 in the present embodiment. Each of the operator terminal 10 and the questionnaire system 30 is communicably connected to the marketing support system 20 in a wired or wireless manner.

In the present embodiment, it is assumed that the operator terminal 10, the marketing support system 20, and the questionnaire system 30 are independent of each other. However, the operator terminal 10 may include the marketing support system 20, and the marketing support system 20 may include the questionnaire system 30.

The operator terminal 10 is, for example, a computer used by a person (operator) who performs marketing activities, and may be configured as one or more computers. Here, marketing activities include the entire process of establishment, implementation, evaluation and improvement of marketing plans.

The operator terminal 10 receives an analysis result from the marketing support system 20 and displays the same. Here, the term “display” refers generally to an output of information such as displaying on a display, printing by a printer, and the like.

Next, the marketing support system 20 is one or more computers that support marketing activities by an operator. The specific configuration and operation of the marketing support system 20 will be described later.

The questionnaire system 30 is a computer that provides the marketing support system 20 with questionnaire information, and is, for example, a server of a research company, an advertising company, or an operator. Here, the questionnaire information is a base material of segment analysis by the marketing support system 20, and, for example, a question included in the questionnaire, a response of a respondent responding to the question, and information indicating an attribute of the respondent (attribute information). The questionnaire information is collected and accumulated at predetermined time intervals (for example, one month, six months, one year, etc.).

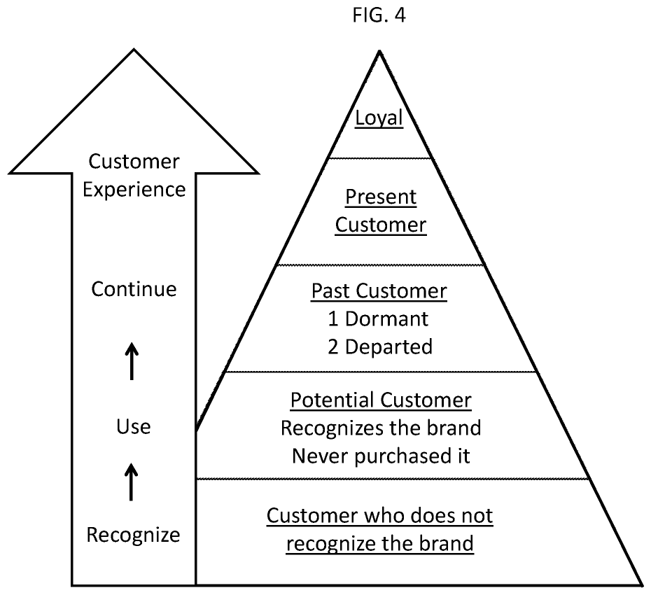

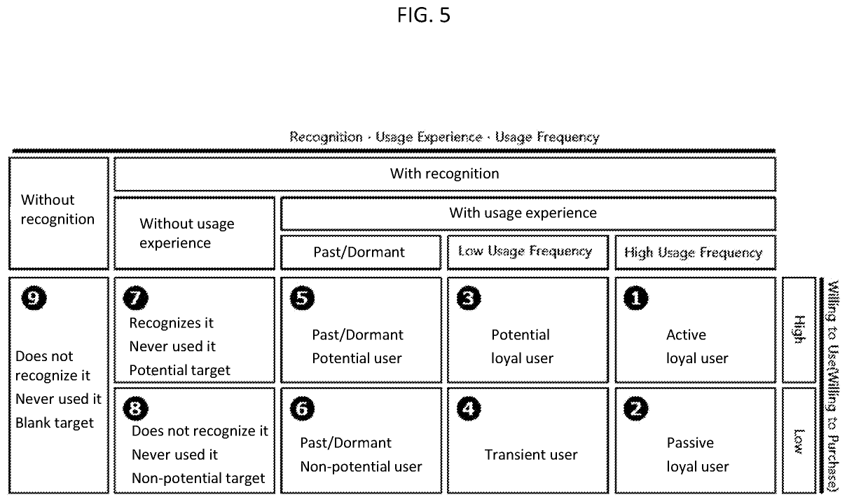

Here, for example, the number of segments is preset to five or nine. Specifically, as shown in FIG. 4, customers may be classified into five segments of a loyal customer, present customer, past customer, potential customer and customer who does not recognize the brand according to customer experience such as whether a specific brand is recognized or not, frequency of purchase (use) of the brand, whether the brand is continuously purchased (used) or not, and frequency of use and so on. Alternatively, as shown in FIG. 5, according to whether there is a purchase intention of the brand (brand preference) (high or low), four segments of a loyal customer, present customer, past customer and potential customer may each be divided into two, to be a total of nine segments.

In the present embodiment, the response results of the questionnaire are used to distribute the respondents of the questionnaire into five segments or nine segments. The questionnaire asks about a specific brand and/or multiple brands that belong to product A (including service) to be marketed. Here, as the product A, there are, for example, automobiles, cosmetics, internet news sites, and so on. Further, as a brand, there are, for example, Toyota (trademark), Nissan (trademark), Honda (trademark) and so on in the case of automobiles.

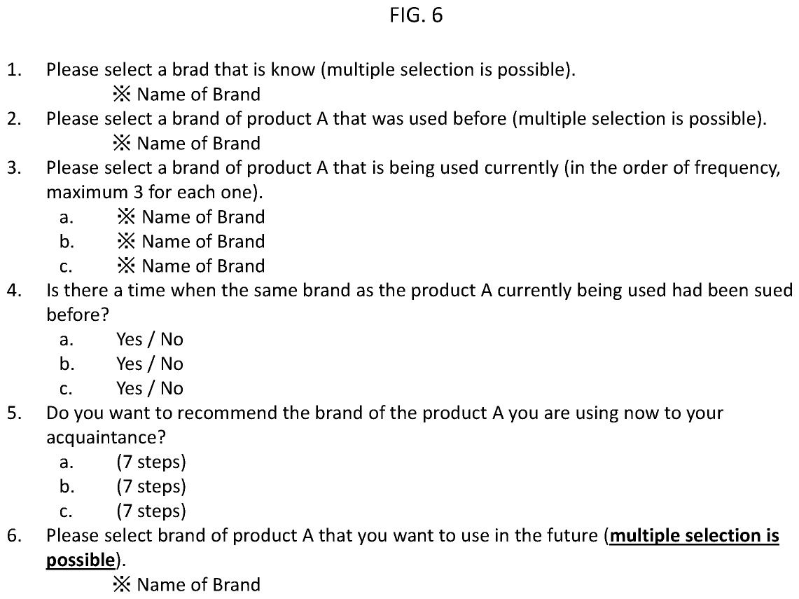

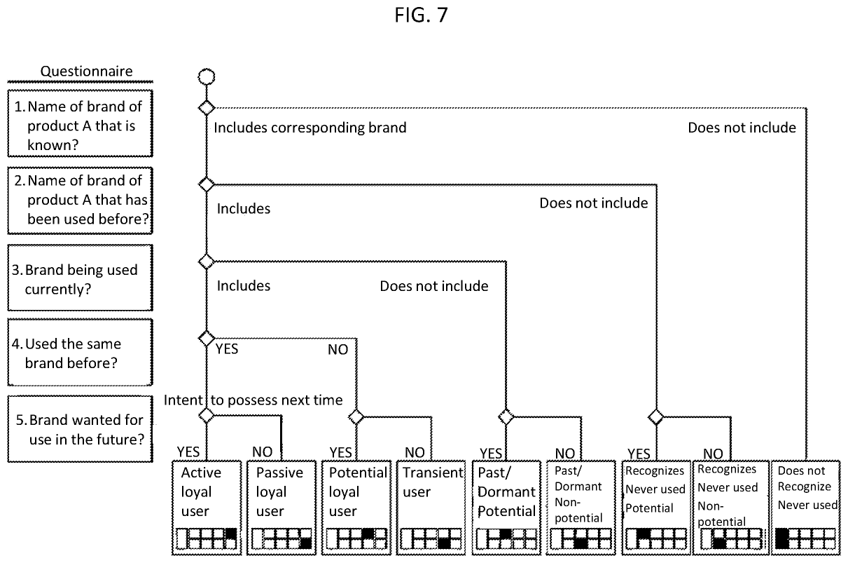

As an example of questions in the questionnaire, as shown in FIG. 6, the respondent is made to select a brand of product A that he/she knows, a brand of product A that has been used before, and a brand of product A that is being used currently, and at the same time asking if the brand of product A that is being used currently has been used before also. These questions ask the respondent about customer experience, and based on the responses to these questions, each respondent is assigned to one of five segments (see FIG. 7).

Also, in the questionnaire, a brand of product A that is thought to be preferable to use later can be selected, and it is possible to confirm the intent of respondents to use specific brands. Thus, for example, the respondent can be assigned to any one of the nine segments according to the flow of FIG. 7.

Further, the questionnaire asks the respondent to provide attribute information. The attribute information may include, for example, demographic attributes such as age group, gender, place of residence, family members, occupation, income, and so on as well as psychological attributes, geographical attributes and behavioral attributes. As psychological attributes, geographical attributes, and behavioral attributes, there is for example, how a certain brand was known, a reason for liking a certain brand, an impression of a brand, a media habit of a respondent, an evaluation on a certain product and so on.

Here, it is the role of the marketing support system 20 to assign respondents to segments, but for convenience of description, it is mentioned here. For example, as shown in FIG. 7, first, for the question of selecting a brand of product A that is known, it is determined whether a brand of a marketing target is included in the response result. In the case where the target brand is not included in the response result, the marketing support system 20 assigns the corresponding respondent to a segment of a customer who does not recognize and never used the target brand. On the other hand, if the marketing target is included in the response to the question of the known brand, the marketing support system 20 determines whether the marketing target is included in the response to the question of a brand that has been used before.

Further, in the case where the marketing target is not included in the response to the question to the respondent of a brand that has been used before, the marketing support system 20 places the respondent in a position as a potential customer among the five segments. At the same time, depending on whether the marketing target is included in the response to the question of the brand wanted for use in the future, the marketing support system 20 assigns the respondent to a potential target or a non-potential target among the nine segments. On the other hand, if the marketing target is included in the response to the question of the brand that has been used before, the marketing support system 20 determines whether the target brand is included in the response to the question of the brand currently being used.

Next, in the case where the marketing target is not included in the response to the question of the brand currently being used, the marketing support system 20 places the respondent in a position as a past customer. At the same time, the marketing support system 20 assigns the respondent to a potential user or a non-potential user depending on whether the marketing target is included in the response to the question of the brand wanted for use in the future. On the other hand, if the marketing target is included in the response to the question of the brand currently being used, the marketing support system 20 determines whether the marketing target was used in the past.

Then, if the respondent has never used the marketing target in the past, the marketing support system 20 places the respondent in a position as a present customer. At the same time, the marketing support system 20 assigns the respondent to a potential loyal user or a transient user depending on whether the marketing target is included in the response to the question of the brand wanted for use in the future.

In addition, if there is a past use of the marketing target, the marketing support system 20 assigns the respondent to an active loyal user or a passive loyal user depending on whether the marketing target is included in the response to the question of the brand wanted for use in the future. Questionnaire respondents may be assigned to any one segment in this way.

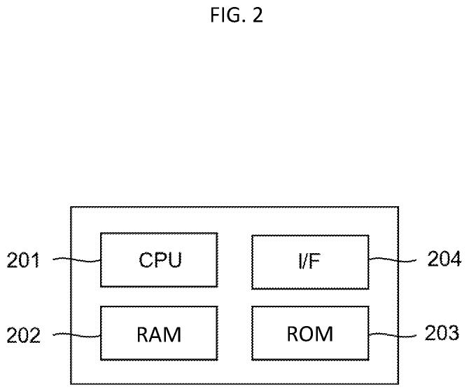

Next, the configuration of the marketing support system 20 will be described in detail. FIG. 2 is a diagram illustrating an example of a hardware configuration of a computer used as the marketing support system 20. The marketing support system 20 is configured to have a CPU 201, a memory 202, a storage device 203, and a communication interface 204.

The CPU 201 realizes various functions of the marketing support system 20 mentioned later by reading various programs in the memory 202 and executing the programs. The storage device 203 is, for example, a hard disk drive, a solid state drive, a flash memory, or the like which stores various data and programs.

The communication interface 204 is an interface for connecting to a communication network, and for example, is an adapter for connecting to Ethernet (registered trademark), a modem for connecting to a public telephone network, a wireless communication device for performing wireless communication, a universal serial bus (USB) connector, RS232C connector and so on for serial communication.

Further, the marketing support system 20 may include an input device (not shown), for example, a keyboard, a mouse, a touch panel, a button, a microphone and the like, and may include an output device (not shown) which outputs data, for example, a display, a printer, a speaker and the like.

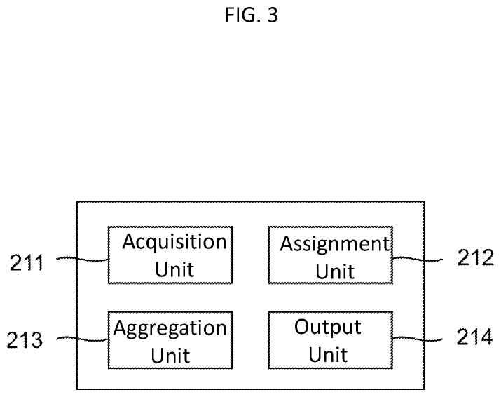

FIG. 3 is a diagram illustrating an example of a software configuration of the marketing support system 20. The marketing support system 20 includes functional units of an acquisition unit 211, an assignment unit 212, an aggregation unit 213, and an output unit 214.

The acquisition unit 211 acquires response information that shows the response results of the questionnaire, and attribute information that shows an attribute of each respondent, from the questionnaire system 30. The response information and the attribute information are described in detail above.

The assignment unit 212 assigns each respondent to any one of a plurality of segments set in advance, based on the response information. The procedure of assignment to segments is described in detail above in relation to FIG. 7.

The aggregation unit 213 aggregates the attributes of the respondents assigned to a corresponding segment for each segment. Here, the aggregation of attribute information can be performed based on the response rate described below.

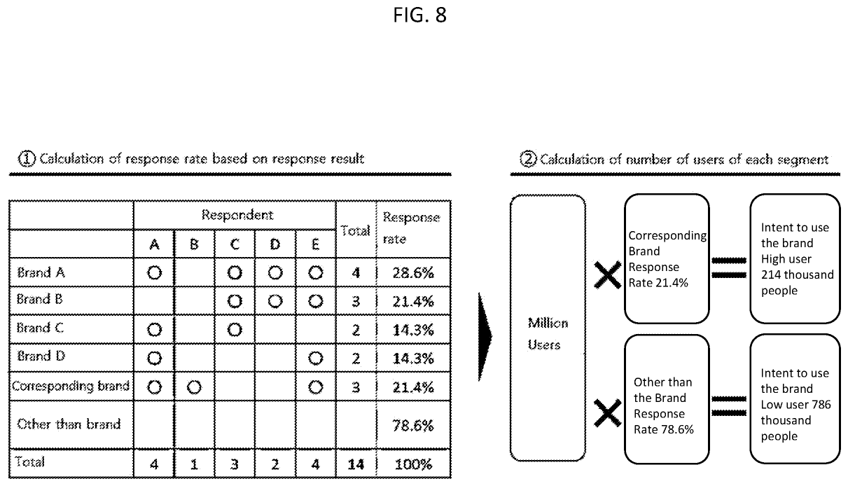

Explaining the response rate using the example of FIG. 8, in a certain questionnaire, respondents A to E select a brand with intentions to use among the brands of product A including brands A to D and the marketing target (“corresponding brand” of FIG. 8). Here, the respondent may select a plurality of brands. In this case, the response rate of the corresponding brand is indicated by the ratio of the total number of selections of the corresponding brand 3 to the total of 14 selections in the entire questionnaire and is 21.4% in the example of FIG. 8.

In addition, by using statistical information, it is possible to calculate the number of users who have a high intention to use the corresponding brand. For example, if there is a statistic that there are 1 million users of product A, the number of users who intend to use the brand can be calculated as 214,000, which is 1 million people multiplied by 21.4%.

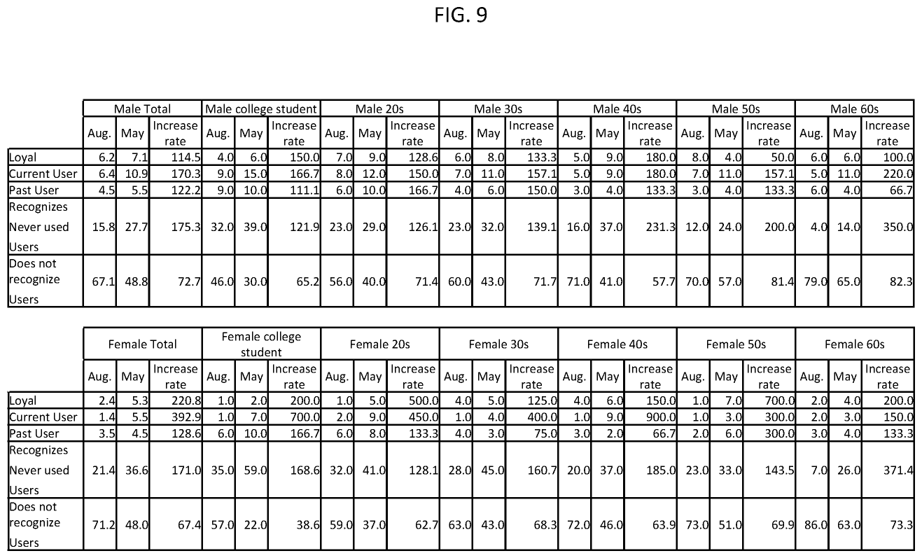

In this way, it is possible to calculate, for each segment, the ratio and number of users having a specific attribute (e.g., age group; male, female; occupation and so on) among the users belonging to that segment. (See FIGS. 9 to 15).

Then, the output unit 214 may display an aggregation result of the aggregation unit 213 to compare between different segments. Further, the output unit 214 may display the aggregation result to compare the aggregation result with questionnaires having different conduction times. Here, displaying means to visualize the above-mentioned analysis result by, for example, displaying it on the display of an operator terminal 10 or printing it with a printer. The displaying may be performed according to a preset display item, or may be performed for an item instructed by the operator via the operator terminal 10.

Here, examples of visualization of aggregation results are shown in FIG. 9 to FIG. 15. In FIG. 9, attribute configurations (distinguished by gender and by age) of users belonging to each of the five segments are shown for two different time periods. At the same time, the increase and decrease of the attribute configuration of users in these two periods is displayed. In FIG. 9, the increase and decrease of the attribute configurations are displayed as a rate of change but may be displayed by the number of users according to the increase and decrease.

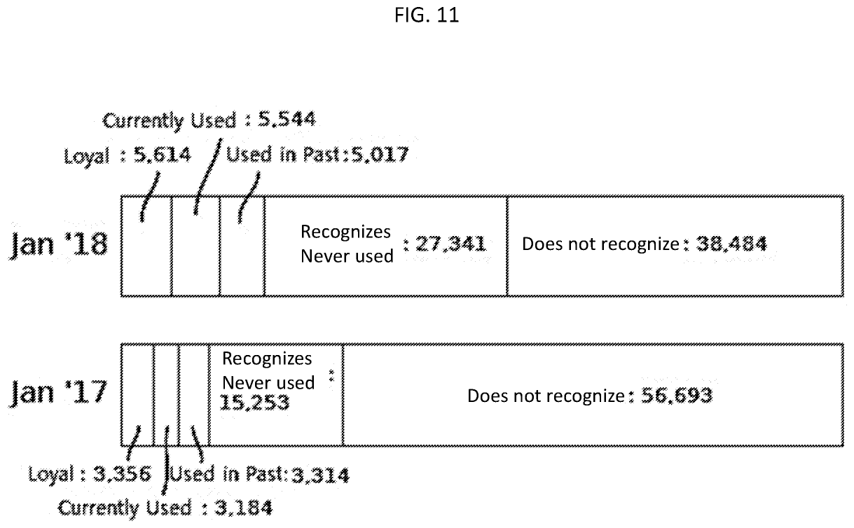

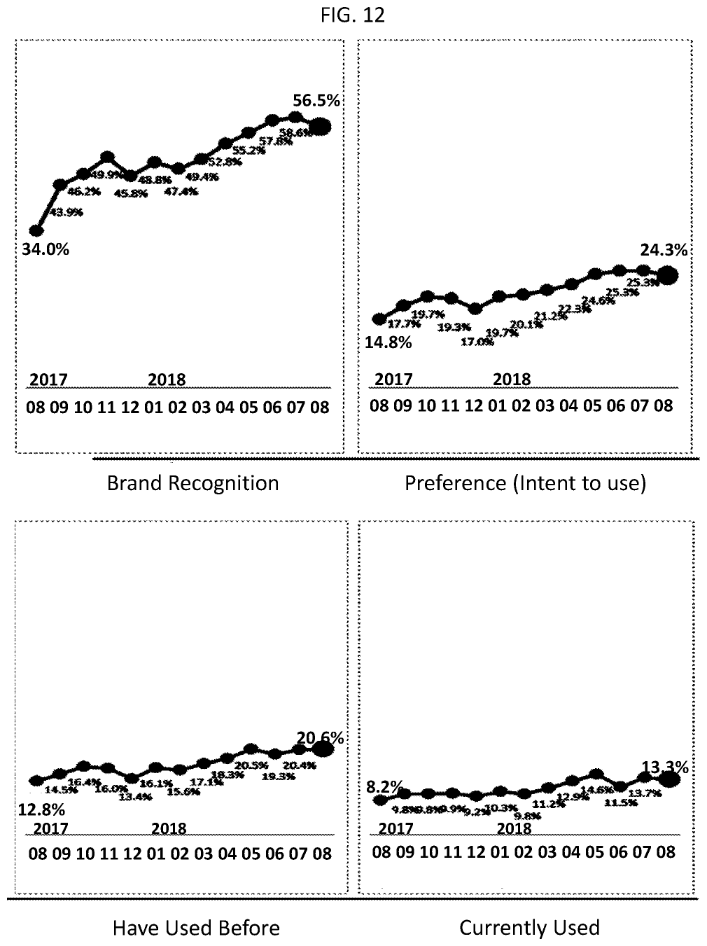

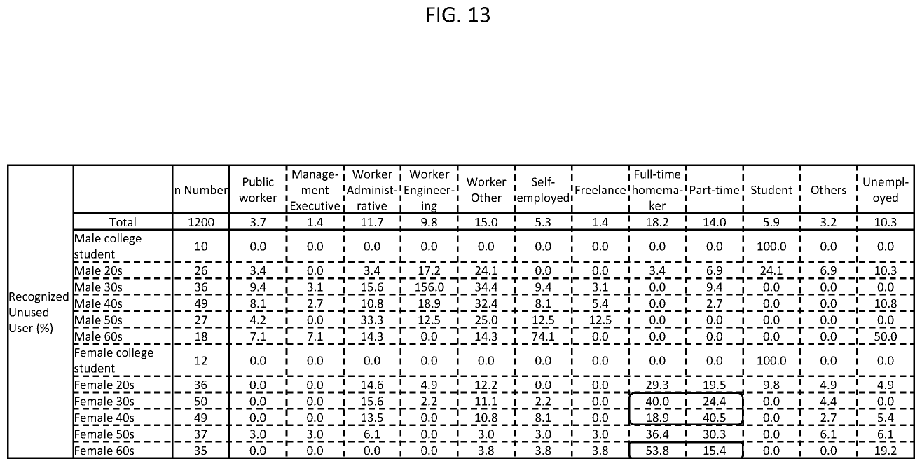

The operator may find out a gap that separates segments (a significant difference between segments in the number or ratio of users having a specific attribute) by comparing the aggregation results among different segments and can dig it deeper. For example, as shown in FIG. 11, the operator may cut out and graph some of the attribute elements (for example, the number of female users belonging to each segment), and as shown in FIG. 12, the transition of the attribute configuration of segments may be visualized over a long period of time. Alternatively, for example, as shown in FIG. 13, an operator may display a diagram or a table having attributes other than demographic attributes (for example, occupation) for segments of unrecognized users.

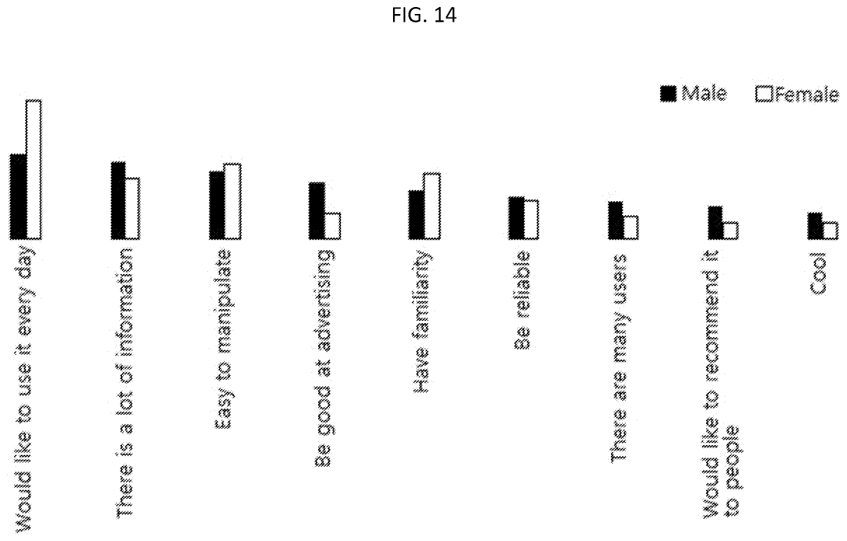

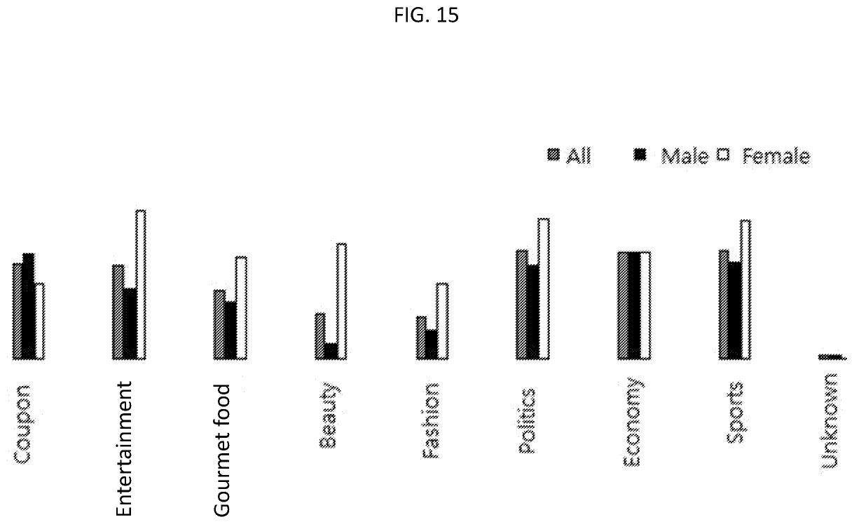

Alternatively, the recognition of the content of the product and brand image of the marketing target may be visualized by segment. For example, FIG. 14 is a graph of a brand image of a marketing target of a loyal user. In the example of FIG. 14, although the brand image is contrasted according to gender, it is possible to be contrasted according to other attributes such as age group, occupation, place of residence, family members, income and the like. Further, FIG. 15 is a graph showing the degree of recognition of the content of the marketing target product (service) of a loyal user. Although the example of FIG. 15 is directed to the recognition level of the overall content of the target product, it is also possible to visualize the recognition level of the specific function and characteristic of the corresponding target product.

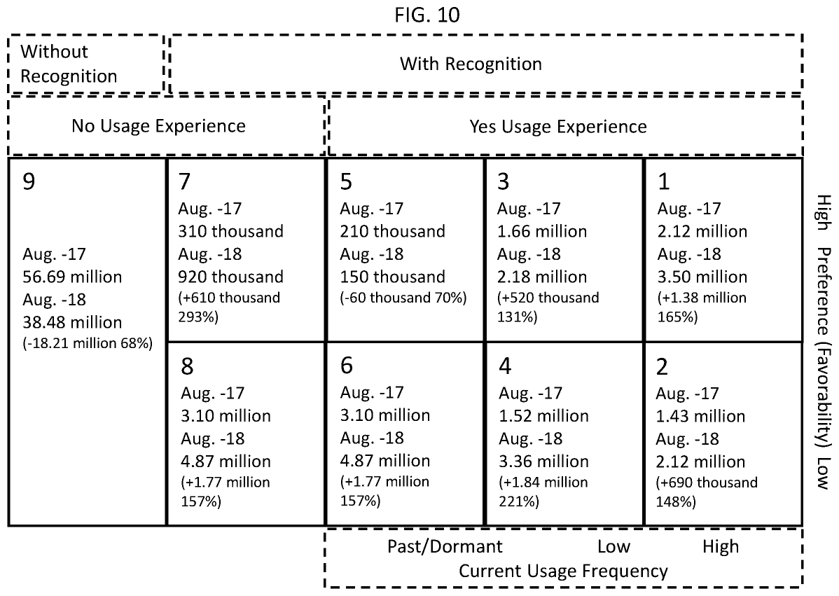

The visualization of the aggregation results corresponding to the nine segments may be performed likewise. For example, FIG. 10 is a visualization of the increase and decrease of the number of male users belonging to each segment and the increase and decrease ratio.

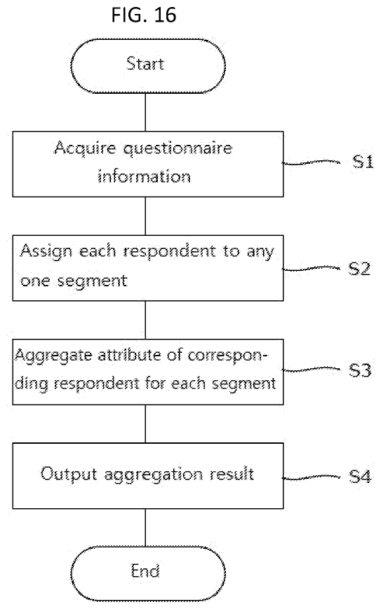

Finally, the operation of the marketing support system 20 is described referring to FIG. 16. First, in step S1, the acquisition unit 211 of the marketing support system may acquire from the questionnaire system 30, questionnaire information including response results of the questionnaire and attributes of the respondent. At this time, in the case where the analysis results of different periods are compared, the acquisition unit 211 acquires all questionnaire information for necessary periods. However, in the case where the marketing support system 20 stores past questionnaire information, the acquisition unit 211 can acquire recent questionnaire information.

Next, in step S2, the assignment unit 212 assigns each respondent to any of the preset plurality of segments. At this time, in the case where analysis results of different time periods are compared, the assignment of respondents to segments are performed for all time periods. However, in the case where the marketing support system 20 stores past assignment results, it is preferable for the assignment unit 212 to assign respondents to segments with respect to latest questionnaire information.

Then, in step S3, the aggregation unit 213 aggregates corresponding respondents for each segment, by attributes preset or instructed by the operator. At this time, in the case of comparing the analysis results of different time periods, the respondents are aggregated for all the necessary times. However, in the case where the marketing support system 20 stores the past aggregation results, the aggregation unit 213 may perform aggregation of the respondents to the latest questionnaire information.

In step S4, the output unit 214 outputs the aggregation result of the aggregation unit 213 according to a preset format or a format instructed by the operator. Further, in the case where there is a significant difference in the attribute configuration of the users between the segments, the corresponding aggregation result may be highlighted by, for example, coloring or bold letters.

Accordingly, this enables the operator to obtain attribute information that is broken down into segments and quantified and visualized for the marketing target brand. Therefore, the operator can obtain an analysis tool that automates the task of comparing, for each segment, various attributes such as the brand image as a marketing target, a user's media habit, product evaluation and the like.

Further described, the operator can compare the processed results of the marketing support system 20 between the segments, and find out the gap separating the segments, which can be useful for qualitative research for in-depth gap analysis. For example, suppose that the analysis result indicates that there is an age difference and “reliable” difference between an active loyal user and a passive loyal user. In this case, it can be hypothesized that communication to a specific age group is biased or that communication is performed only to a specific age group. Therefore, the hypothesis can be confirmed by comparing respective media contact rates and performing a concept test on each segment. Alternatively, it is possible to dig it deeper and perform a more specific hypothesis setting. There is a great convenience of the present embodiment in utilizing such analysis and creating a hypothesis easily.

As mentioned above, although this embodiment was described, the said embodiment is for making an understanding of this invention easy and is not for limiting the interpretation of this invention. The present invention can be modified or improved without departing from the gist thereof, and the present invention also includes the equivalents thereof.

### DESCRIPTION OF REFERENCE NUMERALS

10 Operator terminal
20 Marketing Support System
30 Questionnaire System
211 Acquisition Unit
212 Assignment Unit
213 Aggregation Unit
214 Output Unit

1. A marketing support system comprising,
an acquisition unit acquiring questionnaire information comprising a response result of a questionnaire and an attribute of a respondent of the questionnaire, the questionnaire conducted to consumers in a product and service field to which a marketing target belongs, regarding recognition, usage experience and frequency of use of a brand belonging to the field;
an assignment unit for assigning the respondent to any one of a plurality of segments set in advance based on the response result;
an aggregation unit configured to aggregate the respondent assigned to a corresponding segment by attribute with respect to each of the plurality of segments, and
an output unit for displaying an aggregation result of the aggregation unit between different segments for comparison.

2. The marketing support system according to claim 1, wherein the output unit displays questionnaires conducted at different time periods for comparison.

3. The marketing support system according to claim 1,
wherein the acquisition unit acquires the questionnaire information further comprising a response result of a questionnaire relative to the intent to use the brand, and
the assignment unit assigns the respondent to any one of a plurality of segments set in advance based on the response result of the questionnaire related to the intent of the use of the brand.

4. The marketing support system according to claim 2,
wherein the acquisition unit acquires the questionnaire information further comprising a response result of a questionnaire relative to the intent to use the brand, and
the assignment unit assigns the respondent to any one of a plurality of segments set in advance based on the response result of the questionnaire related to the intent of the use of the brand.

5. A marketing support method, wherein a computer comprising a computing device and a storage device executes,
a step acquiring questionnaire information comprising a response result of a questionnaire and an attribute of a respondent of the questionnaire, the questionnaire conducted to consumers in a product and service field to which a marketing target belongs, regarding recognition, usage experience and frequency of use of a brand belonging to the field,
a step assigning the respondent to any one of a plurality of segments set in advance based on the response result;
a step aggregating the respondent assigned to a corresponding segment by attribute with respect to each of the plurality of segments, and
a step displaying an aggregation result of the aggregating between different segments for comparison.

6. A program for executing,
a step acquiring questionnaire information comprising a response result of a questionnaire and an attribute of a respondent of the questionnaire, the questionnaire conducted to consumers in a product and service field to which a marketing target belongs, regarding recognition, usage experience and frequency of use of a brand belonging to the field,
a step assigning the respondent to any one of a plurality of segments set in advance based on the response result;
a step aggregating the respondent assigned to a corresponding segment by attribute with respect to each of the plurality of segments, and
a step displaying an aggregation result of the aggregating between different segments for comparison,
with respect to a system comprising a computing device and a storage device.
